(19) United States
(12) Patent Application Publication
(10) Pub. No.: US 2002/0049978 A1
(43) Pub. Date: Apr. 25, 2002

(54) System and method for access and placement of media content information items on a screen display with a remote control device

(76) Inventors: Arturo A. Rodriguez, Norcross, GA (US); John Eric West, Roswell, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/881,516

(22) Filed: Jun. 14, 2001

Related U.S. Application Data
(63) Continuation-in-part of application No. 09/693,784, filed on Oct. 20, 2000.

(51) Int. Cl. G06F 3/00; H04N 5/445; G06F 13/00; H04N 7/173

(52) U.S. Cl. 725/86; 725/37; 725/61; 725/38

(57) ABSTRACT

A system and method for providing interactive media services in a subscriber network television system that, broadly summarized, receives a first user input from a remote control device indicating a user's desire to select an item of media content information displayed in a user interface on a screen; and receives a second user input from the remote control device indicating a user's desire to drag the item of media content information to a screen destination.

### CROSS-REFERENCE TO RELATED APPLICATION

This application is a continuation-in-part of copending U.S. utility application entitled, “Media-On-Demand Filing and Reminder System,” having Ser. No. 9/693,784, filed Oct. 20, 2000, which is entirely incorporated herein by reference.

### TECHNICAL FIELD

The present invention is generally related to television systems, and more particularly, is related to a system and method for moving media content information items on a display screen with a remote control device.

### BACKGROUND OF THE INVENTION

With recent advances in digital transmission technology, subscriber television systems are now capable of providing much more than the traditional analog broadcast video. In implementing enhanced programming, the home communication terminal device (“HCT”), otherwise known as the set-top box, has become an important computing device for accessing media services (and media content within those services) and navigating a user through a maze of available services. In addition to supporting traditional analog broadcast video functionality, digital HCTs (or “DHCTs”) now also support an increasing number of two-way digital services such as video-on-demand.

Typically, a DHCT is connected to a cable or satellite, or generally, a subscriber network television system, and includes hardware and software necessary to provide the functionality of the digital television system at the user's site. Some of the software executed by a DHCT is downloaded and/or updated via the subscriber network television system. Each DHCT also typically includes a processor, communication components, and memory, and is connected to a television or other display device, such as a personal computer. While many conventional DHCTs are stand-alone devices that are externally connected to a television, a DHCT and/or its functionality may be integrated into a television or personal computer or even an audio device such as a programmable radio, as will be appreciated by those of ordinary skill in the art.

As more and more services and applications are provided, subscriber network television systems are providing displayable media content information to the DHCTs so that the users can view such information on the display monitors or televisions connected to the DHCTs. The media content information allows the viewers to learn more about the media content available for viewing throughout different time periods by including such information as title and start and end times of the media content. This media content information has traditionally been organized for presentation purposes into a media guide format that presents the media content information by time and channel only. The media guide can, for instance, automatically scroll the available television channels to present the media content information.

DHCTs are capable of providing users with a very large number and variety of media content choices at any particular point in time. Since a viewer is provided access to media content information available at the current time and future periods, as the number of available media content choices increases, it can become inconvenient and time consuming for users to continually browse through unwanted media content information, such as media content titles (for example, the titles of each program or movie), in order to find the ones that they like. Furthermore, users are often confronted with a choice of many desirable media content titles to choose from such that after selecting and viewing a desirable media content title, they often forget the names of other media content titles that they were interested in viewing. Moreover, because of the vast number of media content titles, a viewer wishing to perform a rudimentary operation on multiple media content titles must endure a selection and activation process that requires interactive navigation through a sequence of displayed menus or lists to enact the operation on each respective media content title.

Thus, a heretofore unaddressed need exists in the industry to make it easier and more convenient for users to select and manipulate desirable media content information.

### SUMMARY OF THE INVENTION

The preferred embodiment of the present invention provides, among other things, a system and method for providing interactive media services in a subscriber network television system that, broadly summarized, receives a first user input from a remote control device indicating a user's desire to select an item of media content information displayed in a user interface on a screen; and receives a second user input from the remote control device indicating a user's desire to drag the item of media content information to a screen destination. Other systems, methods, features, and advantages of the present invention will be or become apparent to one with ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The preferred embodiments of the present invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an example digital broadband (DBDS) system in accordance with one embodiment of the present invention.

FIG. 2 is a block diagram of an example headend as depicted in FIG. 1 and related equipment, in accordance with one embodiment of the present invention.

FIG. 3 is a block diagram of an example DHCT as depicted in FIG. 1 and related equipment, in accordance with one embodiment of the present invention.

FIG. 4A is a block diagram of one example remote control device that may be used to provide user input to the DHCT shown in FIG. 3, in accordance with a first embodiment of the present invention.

FIG. 4B is a block diagram of one example remote control device, similar to the remote control device depicted in FIG. 4A, with an added drag button and drop button, in accordance with a second embodiment of the present invention.

FIG. 4C is a block diagram of one example remote control device, similar to the remote control device depicted in FIG. 4A, with added arrow buttons for more directional functionality, in accordance with a third embodiment of the present invention.

FIG. 4D is a block diagram of one example remote control device, similar to the remote control device depicted in FIG. 4A, with a directional ring, for more directional functionality, in accordance with a fourth embodiment of the present invention.

FIG. 5 is a schematic diagram of selected elements of the remote control device depicted in FIG. 4A, in accordance with one embodiment of the present invention.

FIG. 6 is a flowchart depicting an example method for translation of a selected media content title on a screen display using the example remote control device depicted in FIG. 4A, in accordance with one embodiment of the present invention.

FIG. 7 is a screen diagram of an example screen display illustrating a media selection window wherein media content titles may be selected and moved to a destination container, in accordance with one embodiment of the present invention.

FIG. 8 is a screen diagram of an example screen display illustrating an example browse by selection window responsive to user selection of the browse by button in the example screen display of FIG. 7.

FIG. 9 is a screen diagram of an example screen display illustrating an example media graphical icon trajectory and an example altered media content title list in response to the commencement of a drag and drop mode.

FIG. 10 is a screen diagram of an example screen display illustrating an example shopping list icon with an altered appearance upon penetration of the selected media content title into its spatial proximity.

FIG. 11 is a screen diagram of an example screen display illustrating an example shopping container list with a newly inserted media content title.

### DETAILED DESCRIPTION OF THE PREFERRED EMBODIMENTS

The present invention provides, among other things, a system and method for access and placement of media content information items on a screen display with a remote control device (referred to herein as drag and drop functionality). Media content information items will be understood to mean the physically displayed media content information on a screen display, for instance, the selectable and viewable objects of media content information. For example, a media content title is generally considered media content information (e.g. a program name or movie title). But because a media content title can be displayed on a screen and is selectable, it is also an item of media content information. Accordingly, a movie title appearing on the screen display is referred to herein as a title, or media content title, or generally as an item of media content information (or a media content information item). Similarly, other media content information as will be described herein that can be displayed and selected on the screen display and thus will be referred to as an item of media content information or as a media content information item or item or the like. Note that the item may have characterizing information, or media content information, associated with it. For example, a media content title displayed on a screen has other media content information associated with it, such as ratings, start and end times, etc. And if the associated media content information can be displayed on the screen, it too can be an item of media content information subject to drag and drop functionality. Various embodiments of the system and method now will be described more fully hereinafter with reference to the accompanying drawings, in which various embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those having ordinary skill in the art. Although other embodiments and alternate embodiments will be discussed within the disclosure to assist the reader in understanding the scope of the preferred embodiments, it is understood that such embodiments will not detract from the distinctiveness of the preferred embodiments. Furthermore, all “examples” given herein are intended to be non-limiting and among many others.

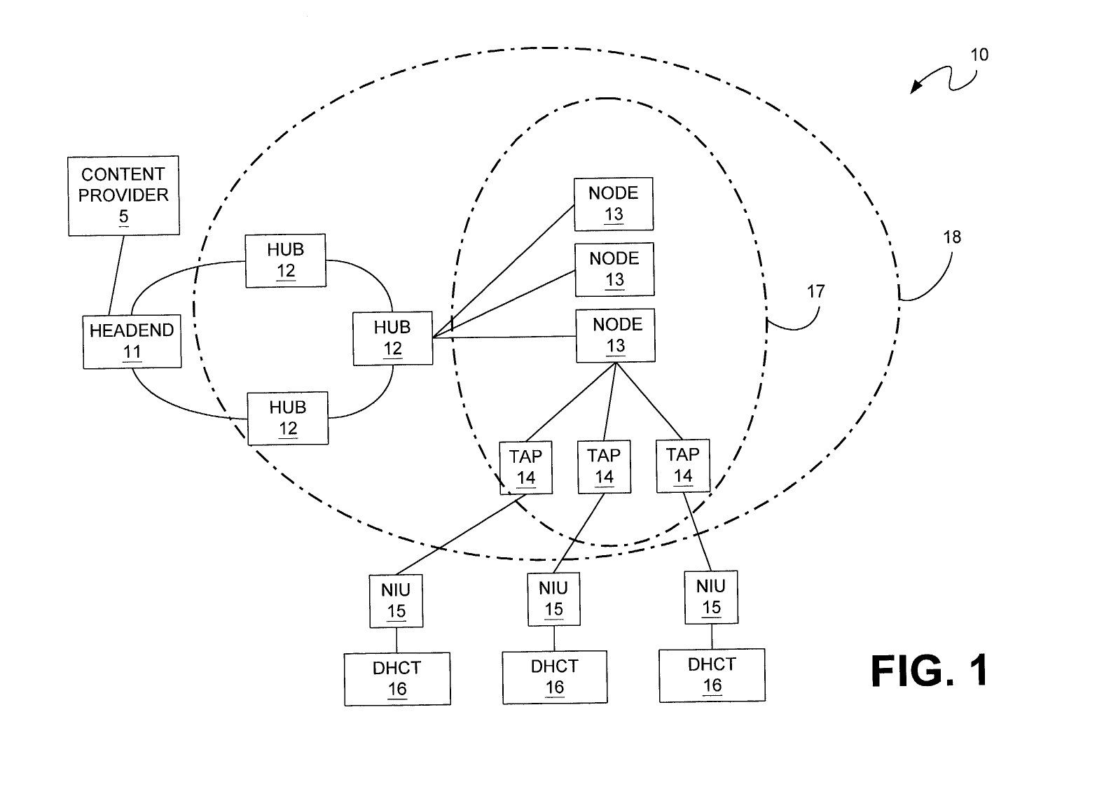

The present invention can, in one embodiment, be implemented as part of a subscriber network television system such as, for example, a digital broadband delivery system (DBDS) or a cable television system (CTS). Hence, an illustrative DBDS and its operation will be described initially, with the understanding that other conventional data delivery systems are within the scope of the present invention. FIG. 1 shows a block diagram view of a DBDS 10, which is generally a high quality, reliable and integrated network system that is typically capable of delivering video, audio, voice and data services to digital home communication terminals (DHCTs) 16. Although FIG. 1 depicts a high level view of a DBDS 10, it should be appreciated that a plurality of DBDS's can tie together a plurality of regional networks into an integrated global network so that DHCT users can receive media content provided from anywhere in the world.

The DBDS 10 preferably delivers broadcast video signals as digitally formatted signals in addition to delivering traditional broadcast analog video signals. Furthermore, the system can preferably support one way broadcast services as well as both one-way data services and two-way media and data services. The two-way operation of the network preferably allows for user interactivity with services, such as Pay-Per-View programming, Near Video-On-Demand (NVOD) programming according to any of several known NVOD implementation methods, View-on-Demand (VOD) programming (according to any of several VOD implementation methods), and interactive applications, such as Internet connections.

The DBDS 10 also provides the interfaces, network control, transport control, session control, and servers to access media content from media services, and distributes media content to DHCT users. As shown in FIG. 1, a typical DBDS 10 comprises a head end 11, hubs 12, an HFC access network 17, and DHCTs 16. It should be appreciated that although a single component (e.g. a head end) is illustrated in FIG. 1, a DBDS 10 can feature a plurality of any one of the illustrated components or may be configured with alternative embodiments for any one of the individual components or with yet other additional components not enumerated above.

Media content provided by one or more content providers, such as content provider 5, is communicated by the content providers to one or more head ends 11. From those head ends 11 the media content and/or data is then communicated over a communications network 18 that includes a plurality of HFC access networks 17 (only one HFC access network 17 is illustrated). The HFC access network 17 typically comprises a plurality of HFC nodes 13, each of which may serve a local geographical area. The hub 12 connects to the HFC node 13 through a fiber portion of the HFC access network 17. The HFC node 13 is connected to a tap 14 which, in one embodiment, is connected to a digital home communication terminal (DHCT) 16. In other embodiments, the tap 14 is connected to a network interface unit (NIU) 15 which is connected to a digital home communication terminal (DHCT) 16. The NIU 15 is normally located at a user's property and provides a transparent interface between the HFC node 13 and the users'internal wiring. Coaxial cables are typically used to couple nodes 13, taps 14 and NIUs 15 because the electrical signals can be easily repeated with radio frequency (RF) amplifiers.

As the high-level operations of many of the functions of a DBDS 10 are well known to those of skill in the art, further high level description of the overall DBDS 10 of FIG. 1 will not be contained herein. It will be appreciated, however, that the DBDS 10 shown in FIG. 1 is merely illustrative and should not be construed as implying any limitations upon the scope of the present invention. For instance, subscriber network television systems also included within the scope of the invention include systems not utilizing physical structured cabling for transmission, such as, but not limited to, satellite systems. Further, transmission media included within the scope of the invention include, but are not limited to, HFC, optical, satellite, RF, FM, and microwave. Further, data provided from the head end 11 to the DHCTs 16 and programming necessary to perform the functions discussed below will be understood to be present in the DBDS 10, in accordance with the description below.

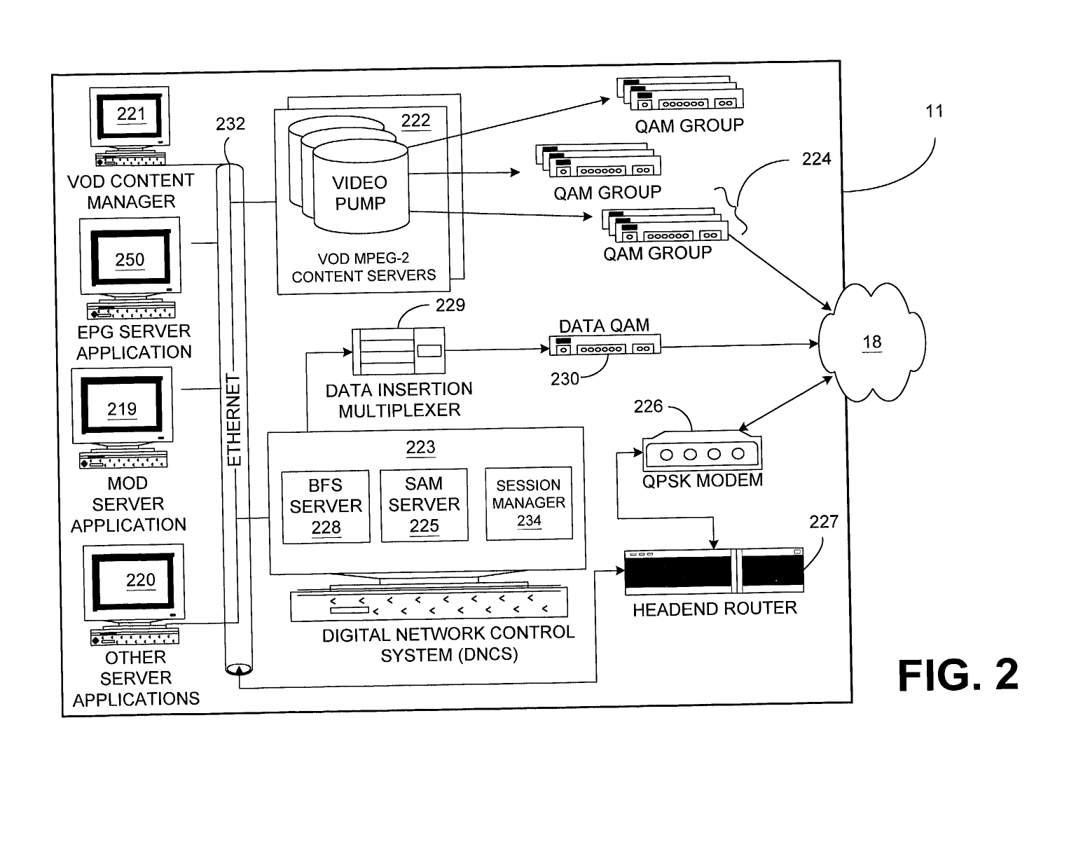

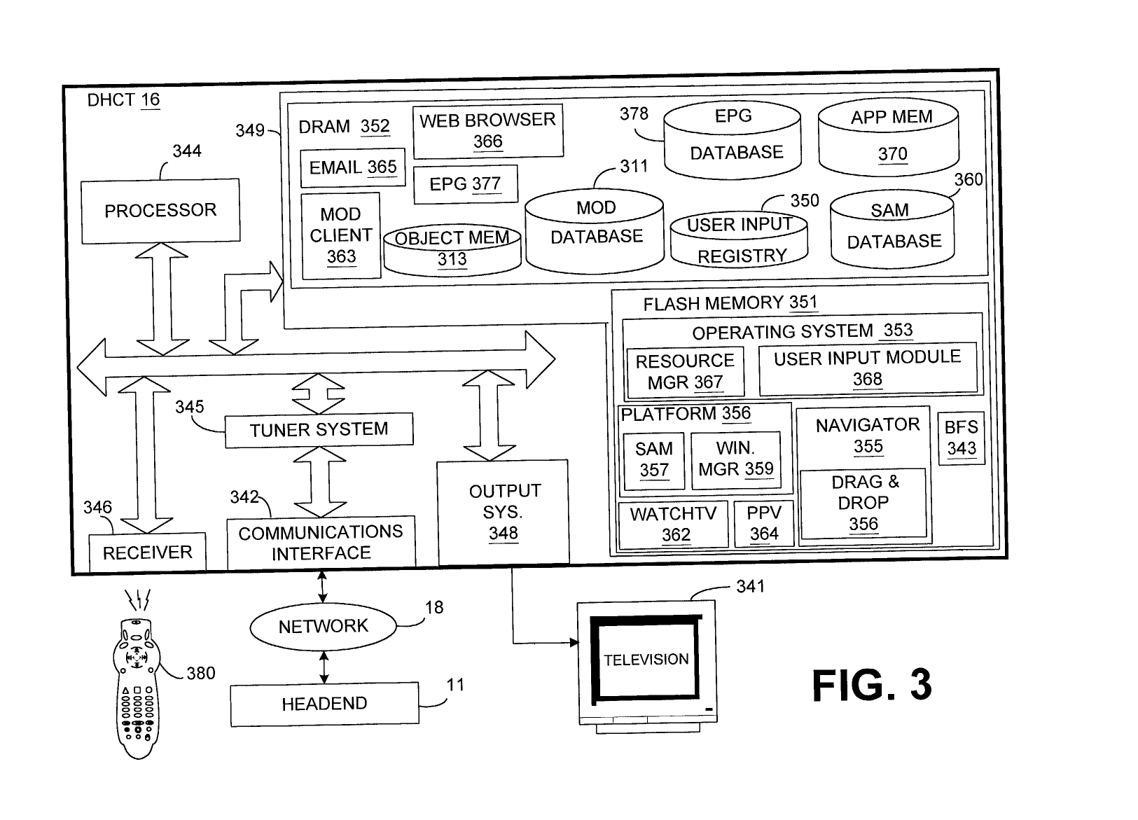

FIG. 2 is a block diagram of portions of an example headend 11 that is configured to provide broadcast and media-on-demand (MOD) services, in accordance with one embodiment of the present invention. It will be understood that the headend 11 shown in FIG. 2 is merely illustrative and should not be construed as implying any limitations upon the scope of the present invention. MOD services include, among other things, video-on-demand (VOD) services and respective MOD information suitable to be presented to a user via display of an interactive media guide. MOD server application 219 and a plurality of other server applications 220 are connected to a digital network control system (DNCS) 223 via a high-speed network such as an Ethernet connection 232. The MOD server application 219 is responsible for reserving and configuring system resources needed to provide MOD services and for providing configuration and service data to a MOD client application 363 (FIG. 3), including MOD information comprising a catalog of media content titles corresponding to media content available for on-demand viewing and/or on-demand rental by a user.

The DNCS 223 provides complete management, monitoring, and control of the network's elements and broadcast services provided to users. In one implementation, the DNCS 223 uses a data insertion multiplexer 229 and a data QAM 230 to insert in-band broadcast file system (BFS) data into an MPEG-2 transport stream that is broadcast and received via DHCT's communication interface 342 and tuner system 345 (FIG. 3). The DNCS 223 also contains a session manager 234 that preferably uses Digital Storage Media Command and Control (DSMCC) protocol to set up and maintain MOD sessions. The session manager 234 processes user to network (U-N) session signaling messages, manages allocation of session-related network resources, supports network management operations, acts as a point of contact to the network for the DHCT's 16 in the network 18 to establish individual sessions, and supports MOD services by providing the signaling interface to establish, maintain and release client initiated exclusive sessions.

A service application manager (SAM) server 225 is a server component of a client-server pair of components, with the client component being located at the DHCT 16. Together, the client-server SAM components provide a system in which the user can access services, which are identified by an application to run and a parameter, such as particular data content, specific to that service. The client-server SAM components also manage the life cycle of the applications on the system, including the definition, activation, and suspension of services they provide and the downloading of the applications into the DHCT 16 as necessary.

Applications on both the headend 11 and the DHCT 16 can access the data stored in a broadcast file system (BFS) server 228 in a similar manner to a file system found on operating systems. The BFS server 228 is a part of a broadcast file system that has a counterpart BFS client module 343 (FIG. 3) in a DHCT 16 connected to the network 18. The BFS server 228 repeatedly sends data for applications on a data carousel (not shown) over a period of time in cyclical repeated fashion so that a DHCT 16 that is in need of reading any particular data file or parts thereof may receive it when requested by a user or one or more of its internal running processes.

A VOD content manager 221 is responsible for managing the content on the VOD content servers 222. The MOD server application 219 controls both the VOD content manager 221 and the VOD content servers 222 and utilizes them to help deliver the video and audio streams that make up VOD services. In one embodiment, a MOD content manager and MOD content servers (not shown) could run respectively in parallel to the VOD content manager 221 and VOD content servers 222 to manage other types of on-demand media content. In an alternate embodiment a MOD content manager replaces the VOD content manager 221 and the MOD content servers replaces the VOD content servers 222. The QAM modulators that comprise the QAM group 224 receive the MPEG-2 transport streams from the VOD content servers 222, convert them into encrypted RF signals at a specified frequency (channel), and transmit them to a DHCT 16 via the network 18.

The QPSK modem 226 is responsible for transporting the out-of-band IP (Internet protocol) datagram traffic between the distribution headend 11 and a DHCT 16. Data from the QPSK modem 226 is routed by headend router 227 within the headend 11. The headend router 227 is also responsible for delivering upstream application traffic to the various server applications 219 & 220.

FIG. 3 is a block diagram illustrating an example DHCT 16 that is coupled to a headend 11 and to a television 341. It will be understood that the DHCT 16 shown in FIG. 3 is merely illustrative and should not be construed as implying any limitations upon the scope of the present invention. Some of the functionality performed by applications executed in the DHCT 16 (such as the MOD client application 363) may instead be performed at the headend 11 and vice versa. A DHCT 16 is typically situated at a user's residence or place of business and may be a stand alone unit or integrated into another device such as, for example, a television set or a personal computer or an audio device. The DHCT 16 preferably includes a communications interface 342 for receiving signals (video, audio and/or other data) from the headend 11 through the network 18 and for providing any reverse information to the headend 11 through the network 18. The DHCT 16 further includes at least one processor 344 for controlling operations of the DHCT 16, at least one output system 348 for driving the television display 341, and at least one tuner system 345 for tuning into a particular television channel to be displayed and for sending and receiving various types of data or media content from the headend 11. The tuner system 345 includes, in one implementation, an out-of-band tuner for bi-directional quadrature phase shift keying (QPSK) data communication and a quadrature amplitude modulation (QAM) tuner for receiving television signals. Additionally, a receiver 346 receives externally-generated information, such as user inputs or commands from other devices.

The DHCT 16 may also include one or more wireless or wired interfaces, also called communication ports (not shown), for receiving and/or transmitting data to other devices. For instance, the DHCT 16 may feature USB (Universal Serial Bus), Ethernet (for connection to a computer), IEEE-1394 (for connection to media devices in an entertainment center), serial, and/or parallel ports. The user inputs may, for example, be provided by a computer or transmitter with buttons or keys located either on the exterior of the terminal or by a hand-held remote control device or keyboard that includes user-actuated buttons, or the user inputs may be aural.

The DHCT 16 can include one or more storage devices (not shown), preferably integrated into the DHCT 16 through an IDE or SCSI interface, or externally coupled to the DHCT 16 via one of the communication ports described above. The storage device can be optical, but is preferably a hard disk drive.

In one implementation, the DHCT 16 includes system memory 349, which includes FLASH memory 351 and dynamic random access memory (DRAM) 352, for storing various applications, modules and data for execution and use by the processor 344. Basic functionality of the DHCT 16 is provided by an operating system 353 that is preferably stored in FLASH memory 351. Among other things, the operating system 353 includes at least one resource manager 367 that provides an interface to resources of the DHCT 16 such as, for example, computing resources. The operating system 353 further includes at least one user input module 368, as will be described below.

One or more programmed software applications, herein referred to as applications, are executed by utilizing the computing resources in the DHCT 16. The client applications may be resident in FLASH memory 351 or downloaded (or uploaded) into DRAM 352. Applications stored in FLASH memory 351 or DRAM 352 are executed by processor 344 (e.g., a central processing unit or digital signal processor) under the auspices of the operating system 353. Data required as input by an application is stored in DRAM 352 or FLASH memory 351 and read by processor 344 as need be during the course of the application's execution. Input data may be data stored in DRAM 352 by a secondary application or other source, either internal or external to the DHCT 16, or possibly anticipated by the application and thus created with the application at the time it was generated as a software application, in which case it is stored in FLASH memory 351. Data generated by an application is stored in DRAM 352 by processor 344 during the course of the application's execution. DRAM 352 also includes application memory 370 that various applications may use for storing and/or retrieving data.

An application referred to as navigator 355 is also resident in FLASH memory 351. Navigator 355 provides a navigation framework for services provided by the DHCT 16. The navigator 355 preferably handles channel navigation keys on the remote control device 380. It also preferably displays a channel banner with information about the selected channel. The navigator 355 registers for and in some cases reserves certain user inputs related to navigational keys such as channel increment/decrement, last channel, favorite channel, etc. The navigator 355 also provides users with television related menu options that correspond to DHCT functions such as, for example, blocking a channel or a group of channels from being displayed in a channel menu.

Navigator 355 includes drag and drop logic 356, which is preferably executable programming providing, among other functions, support for the implementation of drag and drop functionality as a result of pressing keys, or buttons, on the remote control device 380. Drag and drop functionality enables a user, for example, to use the remote control device 380 to, from a user interface perspective, select among many types of items of media content information (for example, a media content title), to pick-up the selected media content information item, and then “drag”, or move, the media content information item (along with the associated functionality) to a destination in another part of the screen or other screens in a quick and efficient manner, as will be described in greater detail below.

The FLASH memory 351 also contains a platform library 356. The platform library 356 is a collection of utilities useful to applications, such as a timer manager, a compression manager, a configuration manager, an HTML parser, a database manager, a widget toolkit, a string manager, and other utilities (not shown). These utilities are accessed by applications via application programming interfaces (APIs) as necessary so that each application does not have to contain these utilities. Two components of the platform library 356 that are shown in FIG. 3 are a window manager 359 and a service application manager (SAM) client 357. The window manager 359 provides a mechanism for implementing the sharing of the display device screen regions and user input. The window manager 359 on the DHCT 16 is responsible for, as directed by one or more applications, implementing the creation, display, and de-allocation of the limited DHCT 16 screen resources. It allows multiple applications to share the screen by assigning ownership of screen regions, or windows. The window manager 359 also maintains, among other things, a user input registry 350 in DRAM 352 so that when a user enters a key or a command via the remote control device 380 or another input device such as a keyboard or mouse, the user input registry 350 is accessed to determine which of various applications running on the DHCT 16 should receive data corresponding to the input key and in which order. As an application is executed, it registers a request to receive certain user input keys or commands, also called events. Events are the typical manner of communication between the operating system 353 and applications. When the user presses a key corresponding to one of the commands on the remote control device 380, the command is received by the receiver 346 and relayed to the processor 344. The processor 344 dispatches the event to the operating system 353 where it is forwarded to the window manager 359 which ultimately accesses the user input registry 350 and routes data corresponding to the incoming command to the appropriate application.

The SAM client 357 is a client component of a client-server pair of components, with the server component being located on the headend 11, typically in DNCS 223. A SAM database 360 (i.e. structured data such as a database or data structure) in DRAM 352 includes a data structure of services and a data structure of channels that are created and updated by the headend 11. Herein, database will refer to a database, structured data or other data structures as is well known to those of ordinary skill in the art. Many services can be defined using the same application component, with different parameters. Examples of services include, without limitation and in accordance with one implementation, presenting television programs (available through a WatchTV application 362), pay-per-view events (available through a PPV application 364), digital music (not shown), media-on-demand (available through an MOD application 363), and an electronic program guide (EPG) (available through an EPG application 377). In general, the identification of a service includes the identification of an executable application that provides the service along with a set of application-dependent parameters that indicate to the application the service to be provided. For example, a service of presenting a television program could be executed by WatchTV application 362 with a set of parameters to view HBO or with a separate set of parameters to view CNN. Each association of the application component (tune video) and one parameter component (HBO or CNN) represents a particular service that has a unique service I.D. The SAM client 357 also interfaces with the resource manager 367, as discussed below, to control resources of the DHCT 16.

Application clients can also be downloaded into DRAM 352 at the request of the SAM client 357, typically in response to a request by the user or in response to a message from the headend 11. In the example DHCT 16 depicted in FIG. 3, DRAM 352 contains a media-on-demand application (MOD) 363, an e-mail application 365, an electronic program guide application 377, and a web browser application 366. It should be clear to one with ordinary skill in the art that these applications are not limiting and merely serve as examples for this present embodiment of the invention. Furthermore, one or more DRAM based applications may, as an alternative embodiment, be resident in FLASH memory 351. These applications, and others provided by the cable system operator, are top level software entities on the network for providing services to the user.

In one implementation, applications executing on the DHCT 16 work with the navigator 355 by abiding by several guidelines. First, an application utilizes the SAM client 357 for the provision, activation, and suspension of services. Second, an application shares DHCT 16 resources with other applications and abides by the resource management policies of the SAM client 357, the operating system 353, and the DHCT 16. Third, an application handles situations where resources are only available with navigator 355 intervention. Fourth, when an application loses service authorization while providing a service, the application suspends the service via the SAM (the navigator 355 will reactivate an individual service application when it later becomes authorized). Finally, an application client is designed to not have access to certain user input keys reserved by the navigator (i.e., power, channel +/−, volume +/−, etc.).

The MOD client application 363 provides the user with lists of available media content titles to choose from and with video presentations requested by the user. The MOD client application 363 provides video presentations to the user by engaging, preferably, in a direct two-way IP (Internet Protocol) connection with VOD content servers 222 (FIG. 2). The MOD client application 363 is also responsible for providing reminder and filing functionality. In an alternative embodiment, the reminder and/or filing functionality is provided by a separate application that can be selectively aggregated to the MOD client application 363 for purposes of charging separately for that functionality.

The MOD client application 363 execution effects access to a database of records containing information pertaining to media content. This MOD database 311 is supported by the client-server MOD counterparts, MOD server application 219 (FIG. 2) and MOD client 363. The MOD client 363 accesses information in the MOD database 311 in memory 352 for presentation to a subscriber. The MOD database 311 contains sufficient information for the presentation of available media content titles at the current time and during subsequent periods. The MOD server application 219 in communication with MOD client 363 effects updates to the MOD database 311 stored in memory 352 or stored in a storage device (not shown) coupled to DHCT 16. MOD client 363 reads records of the MOD database 311 and processes them into a displayable representation as part of a graphical user interface (GUI) displayed on a television 341 or similar display device for presentation to a subscriber.

Execution of electronic program guide (EPG) client application 377 effects access to a database of records containing information pertaining to programs (i.e. media content). This EPG database 378 is supported by the client-server EPG counterparts, EPG server application 250 (FIG. 2), and EPG client 377. The EPG client 377 accesses information in the EPG database 378 in memory 352 for presentation to a subscriber. The EPG database 378 contains sufficient information for the presentation of available program titles (i.e. media content titles) at the current time and during subsequent periods. The EPG server application 250 in communication with EPG client 377 effects updates to the EPG database 378 stored in memory 352 or stored in a storage device (not shown) coupled to DHCT 16. EPG client 377 reads records of the EPG database 378 and processes them into a displayable representation as part of a graphical user interface (GUI) displayed on a television 341 or similar display device for presentation to a subscriber.

MOD and program information (herein media content information) comprises data organized into a database of records for each application with fields containing, but not limited to, information such as media content title, media content description, media content genre, release year, casts or performers list, ratings information, start time and play duration.

Media content information associated with media content titles is transmitted on a regular or periodic basis from MOD server application 219 (or EPG server application 250 for programs) (FIG. 2) to one or more DHCTs 16. Media content information populates the entries of a list, menu or container in a GUI presentation, from which a subscriber can select, for example, a media content title that is available at the current time or in the future. Hence, per media content information in the displayed presentation to the subscriber, the subscriber can select a media content title and enact a pick-up operation, and then drag the picked-up media content title to a destination container and enact a drop-off operation, as will be described in greater detail below.

The DHCT 16 also includes object memory 313, which is used for storing picked-up-object status information corresponding to the drag and drop functionality, as will be described in greater detail below.

An executable program or algorithm corresponding to an operating system (OS) component, or to a client platform component, or to a client application, or to respective parts thereof, can reside in and execute out of DRAM 352 and/or FLASH memory 351. Likewise, data input into or output from any executable program can reside in DRAM 352 or FLASH memory 351. Furthermore, an executable program or algorithm corresponding to an OS component, or to a client platform component, or to a client application, or to respective parts thereof, can reside in FLASH memory 351, or in a local storage device coupled to DHCT 16 and be transferred into DRAM 352 for execution. Likewise, data input for an executable program can reside in FLASH memory 351 or a storage device and be transferred into DRAM 352 for use by an executable program or algorithm. In addition, data output by an executable program can be written into DRAM 352 by an executable program or algorithm and be transferred into FLASH memory 351 or into a storage device for storage purposes. The preferred embodiments of the present invention are not limited by where or how data and/or applications are stored or retrieved.

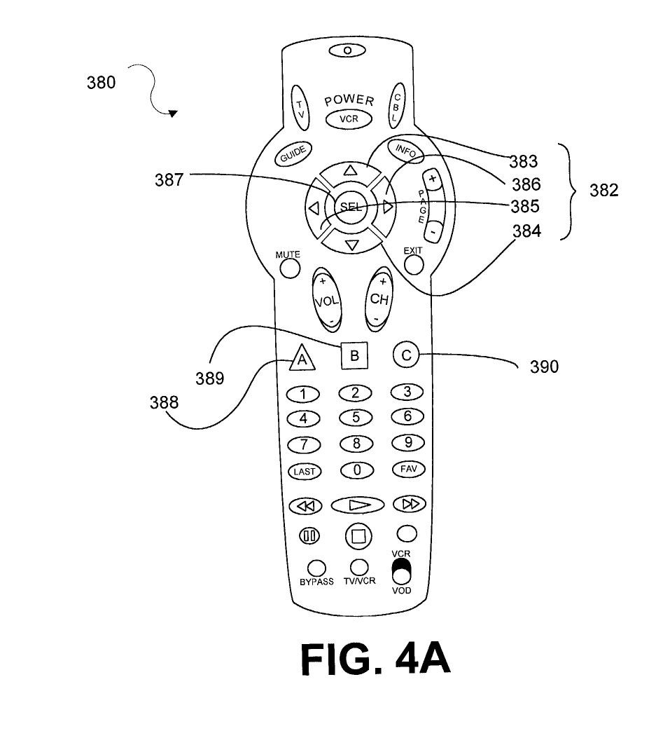

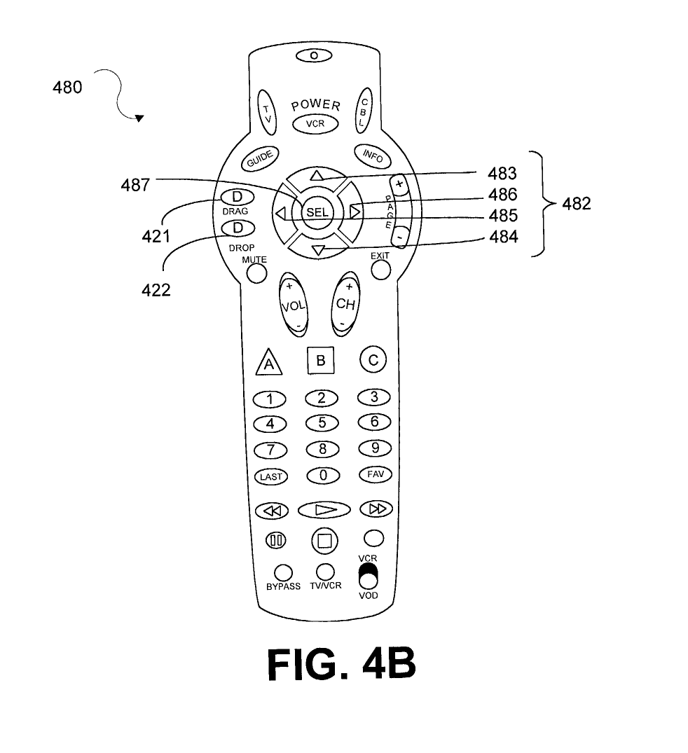

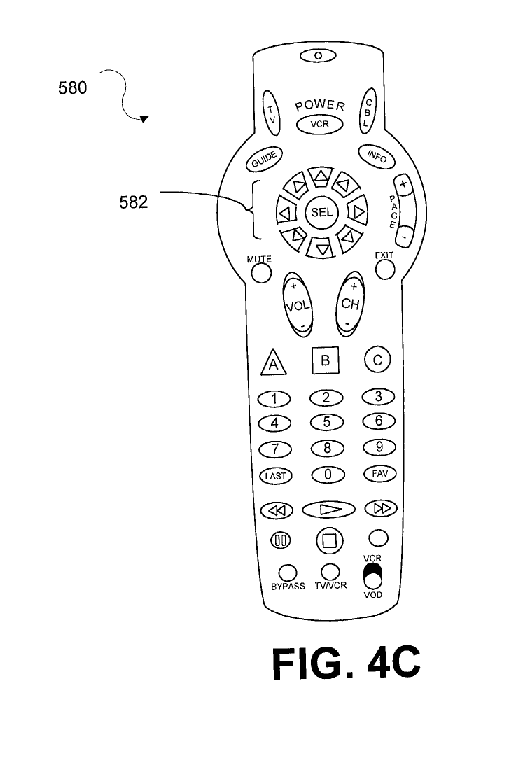

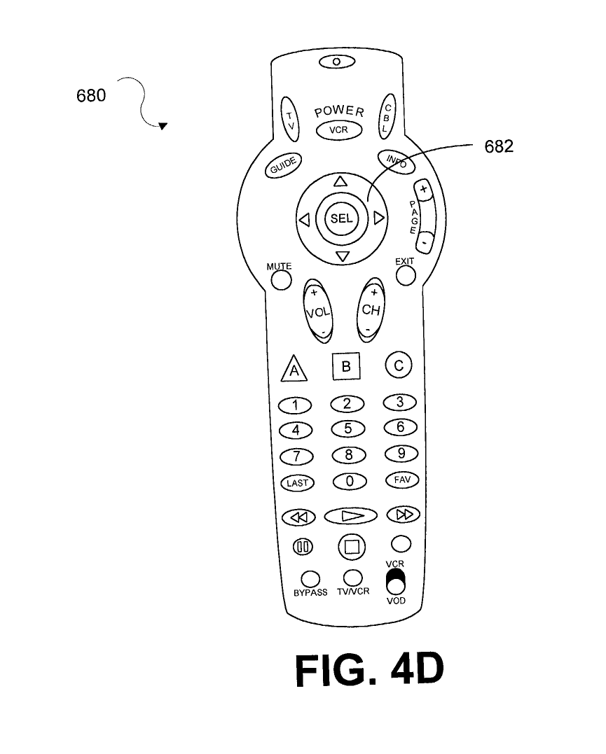

FIG. 4A is a block diagram illustration of an example remote control device 380 that is used to provide user input to the DHCT 16. The arrow buttons 382 include an up arrow button 383, a down arrow button 384, a left arrow button 385, and a right arrow button 386 that are used to scroll through options and/or to highlight an option and/or to navigate an item of media content information across a screen display. The select, or activation, button 387 may be used to select a currently highlighted option that is provided to the user, as well as to facilitate drag and drop functionality. Further, “A” 388, “B” 389, and “C” 390 buttons can correspond to certain application-defined functions that have a corresponding “A”, “B”, or “C” symbol displayed on the user interface. FIG. 4B is a block diagram illustration of an example remote control device 480, similar to the remote control device 380 of FIG. 4A, but with an added drag button 421 and drop button 422 to provide for drag and drop functionality, as will be described in greater detail below. Also included are arrow buttons 482 and a select button 487. FIG. 4C is a block diagram illustration of an example remote control device 580 similar to that illustrated in FIG. 4A, but with four additional arrow buttons 582 for improved directional navigation functionality. FIG. 4D is a block diagram illustration of an example remote control device 680 similar to that illustrated in FIG. 4A, but with a directional ring 682, in place of the discrete directional arrow portions, for infinite directional navigation capability. Many alternative embodiments exist, including, for example, a remote control device with a directional ball or disc to provide infinite directional functionality, and/or selection functionality.

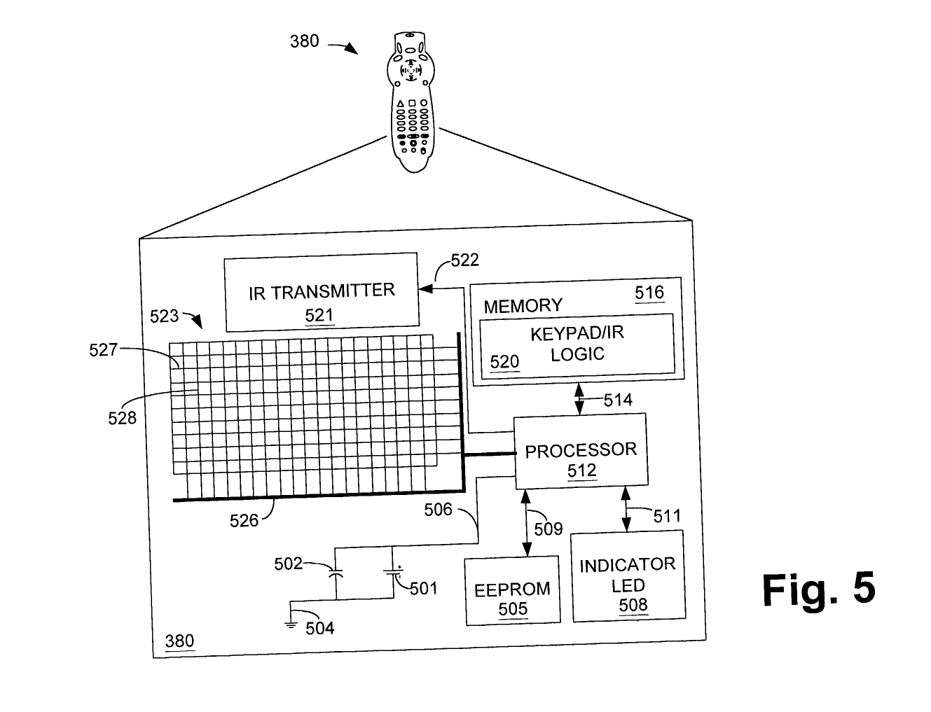

FIG. 5 is a schematic diagram of selected elements of the example remote control device 380 of FIG. 4A with, for example, infrared (IR) communication capabilities. Although an example remote control device 380 with IR functionality is shown, it will be understood that other forms of communication functionality are included within the scope of the present invention, including but not limited to audio communication. Remote control device 380 includes keypad matrix 523, which includes horizontal lines, an exemplary one of which is indicated by reference numeral 527, and vertical lines, an exemplary one of which is illustrated by reference numeral 528. Typically, buttons on the remote control 380 are located at the intersection of horizontal lines 528 and vertical lines 527. When actuated, i.e. pressed, the button associated with the intersection of horizontal lines 527 and vertical lines 528 within keypad matrix 523 causes an electrical connection to be made at the intersecting lines. In this manner, when a button on the remote control device 380 is pressed, a circuit is completed at the particular intersection of vertical and horizontal lines corresponding to the pressed button and a signal is sent via communication bus 526 to processor 512. Processor 512 analyzes the received signal and, depending upon which horizontal line and which vertical line are indicated by the button press, determines which function or key has been pressed.

Remote control 380 also includes power source 501, which is typically a replaceable battery, and bypass capacitor 502. Power source 501 and bypass capacitor 502 are grounded at location 504 and communicate via connection 506 with processor 512. Processor 512 is also connected via connection 511 to an indicator light emitting diode (LED) 508. Indicator LED 508 indicates when an IR signal is being transmitted and also functions as a low battery indicator.

Processor 512 is also connected via connection 509 to electrically erasable programmable read only memory (EEPROM) 507. EEPROM 507 contains the remote control device 380 functions in a non-volatile memory arrangement so that when the battery in the remote control device 380 is replaced, the remote control device 380 does not lose its memory. Processor 512 communicates via connection 514 with memory 516. Memory 516 is typically a random access memory (RAM) that contains the keypad IR logic 520 of the invention. When processor 512 detects a key press from keypad matrix 523, processor 512 accesses memory 516 and keypad IR logic 520 to determine which IR code corresponds to the detected key press. Once the processor 512 determines the correct IR code based on the detected key press, the processor 512 communicates with IR transmitter 521 via connection 522 to emit an appropriate IR signal containing the appropriate key code to an IR receiver.

With reference to FIG. 3, and continued reference to FIG. 5, remote control device 380 transmits an IR signal, which is received in the DHCT 16 by receiver 346. Although illustrated as being transmitted to a DHCT 16, the IR signal transmitted by remote control device 380 can be received by any communication box such as the DHCT 16, directly by a television 341, or other peripheral devices. Receiver 346 demodulates the received IR signal, and stores it in a temporary memory, preferably a first-in-first-out memory residing in IR receiver 346, and then notifies processor 344. The notification may be effected by an interrupt generated directly or indirectly by IR receiver 346 or by processor 344 polling status of registers in IR receiver 346 on a regular or periodic basis.

The user input module 368 (or driver) that is part of operating system 353 executes on processor 344 to attend key presses and releases from the user's input device, such as remote control device 380, and fulfills the aforementioned functionality in communication with IR receiver 346. A sequence of one or more demodulated IR signals corresponding to key presses and/or releases are transferred to memory 349. Each key press or release is converted by the operating system 353 in cooperation with the user input module 368 to a key event that the modules of the operating system 353, including window manager 359, and other applications understand. In an alternate embodiment, IR receiver 346 performs the conversion to key events prior to storing in its temporary FIFO memory. After the IR code has been stored (and converted to a key event), window manager 359 causes processor 344 to generate an interrupt, which informs drag and drop logic 356 that an IR key event has been received as explained above. Drag and drop logic 356 then retrieves the register value from memory 349 and performs the required action corresponding to the received IR key event. Furthermore, because an IR protocol typically implements transmission and reception of continuous IR codes spaced at certain time intervals, for example 37 milliseconds apart, the processor 344 has the capability to determine key press events and key release events as well as continuous down key presses. So as long as the same key is pressed, the key event is passing the same key word (or IR code) to the drag and drop logic 356 (via user input module 368) which in turn can make sense of the desired functionality. A dual key press can be interpreted as a one key word. In other embodiments, drag and drop logic 356 (through the user input module 368) can detect a first key press immediately followed by a series of second key presses. For example, to pick up and move desired items of media content information on a screen, the user can first select, with select key 387 (FIG. 4A), a highlighted item of media content information, and then immediately press and hold down one of the arrow keys 382 (FIG. 4A) to cause drag and drop functionality to occur (as will be described in greater detail below). In either embodiment (i.e. for one key word or a series of key presses), any key press in between (for example, by virtue of the user releasing one of the arrow keys 382 and pressing another one of the arrow keys 382 to change direction of translation of an item of media content information) would indicate, via an internal timer, that the user wishes to continue drag and drop. So the user can resume the functionality prior to the timeout if, for example, one of the arrow keys 382 have been released. An internal timer also would cause the drag and drop functionality to time out if no key release signal is received at the DHCT 16.

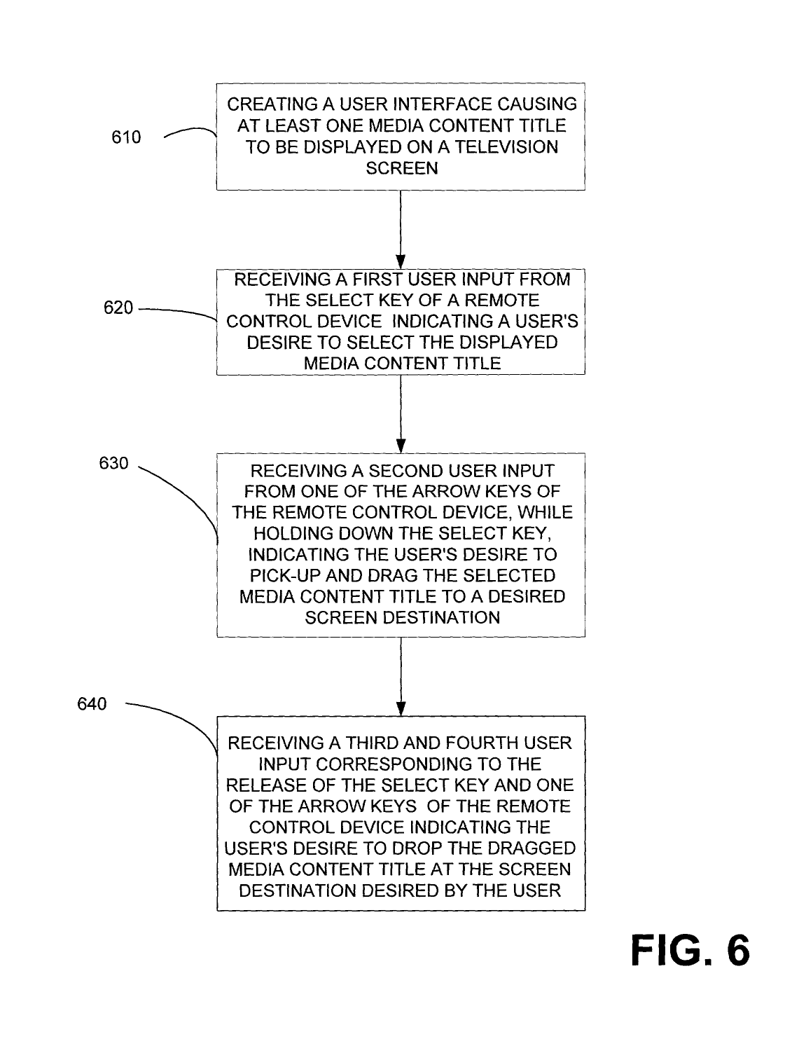

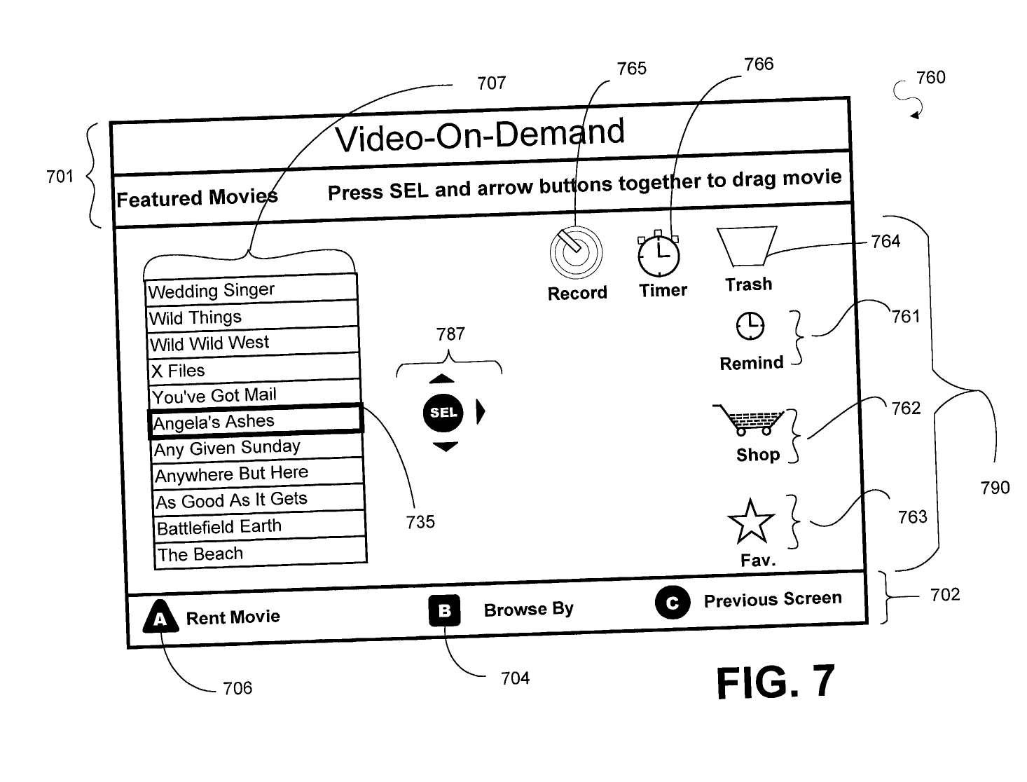

FIG. 6 is a flowchart depicting an example method for moving media content titles on a screen display with the remote control device 380 depicted in FIG. 4A, in accordance with one embodiment of the present invention. Although the example method illustrated in the flowchart of FIG. 6 is described in cooperation with the remote control device 380, other remote control device embodiments are included within the scope of the present invention. Step 610 includes creating a user interface causing at least one media content title to be displayed on a television screen. Step 620 includes receiving a first user input from the select key 387 of remote control device 380 (FIG. 4A) indicating the user's desire to select the displayed media content title. As will be described in greater detail below, the first input may correspond to a highlighted media content title selection from, for example, a media content list displayed on a television screen. Step 630 includes receiving a second user input from one of the arrow keys 382 of the remote control device 380 while holding down the select button 387, indicating a user's desire to pick-up and drag the selected media content title to a screen destination desired by the user. Directional arrow symbols 787 (FIG. 7) on the display screen alert the user to the ability to use the arrow buttons 382 on the remote control device 380 to identify a direction of movement for a picked-up media content title, as will be described below. Note that additional steps may be involved in maneuvering the media content title to its proper destination. For instance, the sequential combination of a right arrow key 386 depression and then an up arrow key 383 depression (while holding down the select button 387) may be used to arrive at the screen destination desired (for example, the trash destination container 764 in FIG. 7). Step 640 includes receiving a third and fourth user input corresponding to the release of the select button 387 and one of the arrow keys 382 of the remote control device 380, indicating the user's desire to release or “drop” the dragged media content title at the screen destination desired by the user.

Referring to step 610 of FIG. 6, the media content title is read from a data structure in memory 352, such as the EPG database 378 or MOD database 311, and prepared in the proper format for display. The active application, for example a VOD application as implemented by MOD client application 363, configures the processor 344 to provide the user with a user interface to display selection options for the user. With reference to FIG. 3, as with other user interface screen display examples discussed below, processor 344 executes program instructions of the active application that cause it to employ the services of the window manager 359 to create a GUI screen display via display data that is formatted for television 341. Processor 344 stores the display data or parts thereof in DRAM 352 (as necessary) and transfers the display data to a display output system such as output system 348 wherein display data is converted to respective television signals and transmitted to television 341. Of course, the scope of the preferred embodiments of the present invention also includes any other method of causing the described user interface screen displays to appear to the user.

Referring to step 630 of FIG. 6, a picked-up media content title causes execution of drag and drop logic 356 in navigator 355 to store sufficient information related to the pick-up operation and to the picked-up media content title to be stored in object memory 313, which is a special section of memory dedicated for picked-up object, or item, status. Although described in the context of a media content title, it will be understood that other media content information items will have corresponding information related to the pick-up operation and the picked-up media content information item. Note that media content title is understood to include MOD and program titles. Pick-up operation information includes the original residence of the media content title (for example, a media content title list, menu or container) and its screen coordinates so that the media content title can be returned to its origin, for example in the event that the pick-up operation is aborted.

Referring to step 630 of FIG. 6, movement (or translation) of the media content title is implemented using drag and drop functionality of the drag and drop logic 356 (FIG. 3), whereby, in one implementation, a highlighted media content title is “dragged” from one location on the television screen and “dropped” into another location on the same or a different screen. Pursuant to user input causing a media content title to be translated (i.e., dragged) in the display, the screen location of the picked-up item is stored in object memory 313 and updated as the item is translated across the screen in either absolute screen coordinates or relative coordinates. Relative screen coordinates comprise delta X and delta Y coordinates relative to the coordinates of the original residence of the media content title.

Pointers to database records in memory 352, wherein the records contain information associated with the picked-up and translated media content title, are also stored in object memory 313. These database records include the records of the MOD database 311 and the EPG database 378. Alternatively, a copy of the information found in the EPG database 378 and MOD database 311, rather than the pointers, can be stored in the object memory 313. Information associated with a picked-up and translated media content title includes, in one implementation, a set of visual graphical icons that represents the type of media content title. A picked-up object (i.e. a visual indication of an item of media content information such as a media content title) is translated across the screen with the respective visual graphical representation, or icon (herein media graphical icon), and displayed on the television screen by updating the location of the media graphical icon on the display repeatedly (for example, 10 times per second) to emulate visual motion across the screen responsive to user input. Different media graphical icons can be designated for different types of media content information items. For instance, a high-definition digital video program may employ a different icon than a standard digital video program, and a different graphical media icon for an analog video program. The shape or color of the media graphical icon and/or the destination container can change as the media graphical icon penetrates the immediate screen real-estate surrounding a container capable of serving as a destination for the media content title (i.e., a visual container capable of accepting the media content information item such as a media content title). Hence, in addition to storing and updating the coordinates of the media graphical icon as it moves across the screen, information about the shape or color of the media graphical icon (and/or the container) representing the picked-up media content title is stored and updated in the object memory 313.

In one embodiment, a picked-up media content title from a first screen can be transferred to a destination container in a second screen. A user can “drag” the picked up media content title towards a destination container designated as a temporary placement container in the first screen and drop the picked-up media content title once it has penetrated the immediate real-estate surrounding the temporary placement container. Upon user input causing display of a second screen, the temporary placement container appears on the same location on the second screen as its location in the first screen. The user can then resume the drag functionality by picking-up the media content title from the temporary placement container. Alternatively, upon entering the second screen, the picked-up media content title appears at approximately the same spatial coordinates of the display where it was left off in the first screen and the user can continue to drag and then drop the picked-up media content title in a container in the second screen. Alternatively, the drag functionality on a second screen commences on a designated spatial area of the display such as a designated corner.

Referring to step 640 in FIG. 6, a dragged media content information item is dropped off in a destination container responsive to two user inputs, in one implementation, the release of the selection key 387 and one of the arrow keys 382 of the remote control device 380 (FIG. 4A). A first type of destination container facilitates organization and compartmentalization functionality. A second type of destination container features operation activation. Examples of containers that activate operations include a container that activates (or sets) a reminder timer on each dropped-off media content title with a future start time, and a container that activates a record operation on each dropped-off media content title. Thus with the drag and drop functionality, the user need not endure a selection and activation process that requires interactive navigation through a sequence of displayed menus or lists to enact the operation on each respective media content title that he or she wishes to activate.

In another embodiment of the invention, drag and drop functionality is enabled in a subscriber's DHCT upon an authorization message sent by the head-end 11. Therefore, the cable operator can charge a separate fee for drag and drop functionality as a featured enhancement.

FIG. 7 is a screen diagram of an example screen display illustrating a media content selection window 760 where media content titles may be selected, picked-up and moved. Many other embodiments of user interface screen displays are possible to implement drag and drop functionality, including, but not limited to, an electronic program guide (EPG) 377 screen display. The example VOD media content selection window 760 has a header portion 701 suggesting the purpose of the screen displayed. Also illustrated is media content title list 707, which provides a list of media content titles for the user to choose from. In an alternative embodiment, a set of distinct functional media content title lists exist, each equivalent to a functional container and having a respective small visual icon representation. Media content selection window 760 also includes a bottom portion 702 with lettered symbols that suggest a functional correspondence to buttons on a remote control device, such as remote control device 380 buttons 388, 389, and 390 (FIG. 4A). Browsing symbol 787 suggests to the user a one-to-one functional correspondence to the select button 387 and arrow keys 382 on the remote control device 380 (FIG. 4A). For example, the user may activate the down arrow button 386 (FIG. 4A) to cause the media content title Any Given Sunday to be displayed in the highlighted title area 735. In an alternative embodiment, activating the up arrow 383 or down arrow 386 would result in shifting the highlighted title area 735 rather than shifting the media content title list 707 (at least until the top or bottom title is highlighted). The user may then press the rent button “A” 388 (FIG. 4A) to rent the highlighted movie, or “select” (for drag and drop purposes) the highlighted media content title for translation and drop off to one or more of the destination containers represented visually by destination container icons 790.

Each of the destination container icons 790 is preferably a small visual color image with a short text string that suggests the functionality of the respective destination container. As illustrated in FIG. 7, media content title selection functionality is enhanced by displaying the destination container icons 790 inside the perimeter of the example VOD media content selection window 760. Destination container icons 790 each suggest to the user various destinations for the selected media content title (or other media content information items). Destination container icons 790 each comprise a list or table for inserting new media content titles or viewing prior inserted media content titles, as will be described in greater detail below. In one implementation, destination container icons 790 include reminder icon 761 as a destination container for retrieving media content titles that the user wants to consider for future viewing, shop cart icon 762 for possible future purchases, and a favorites icon 763 for collecting favorite selections. Destination container icons 790 also include a trash can icon 764, which is used as a destination container for deleting a media content title stored in an existing container and serves as an interim step in the deletion process to provide capability to restore a deleted media content title to its prior container. Also included as destination icons 790 are activation container icons, such as reminder container icon 765 and recording container icon 766, as described above. It will be understood that the destination containers and their respective icons listed above are merely illustrative, and greater or fewer containers and associated icons are within the scope of the present invention. Prior selections within each of the destination containers that comprise a list or table and that is visually represented by the respective destination icons 790 may be accessed by selecting the browse by button “B” 389 (FIG. 4A) on the remote control device 380 (FIG. 4A), as suggested by the “B” browse by symbol 704 on the display screen.

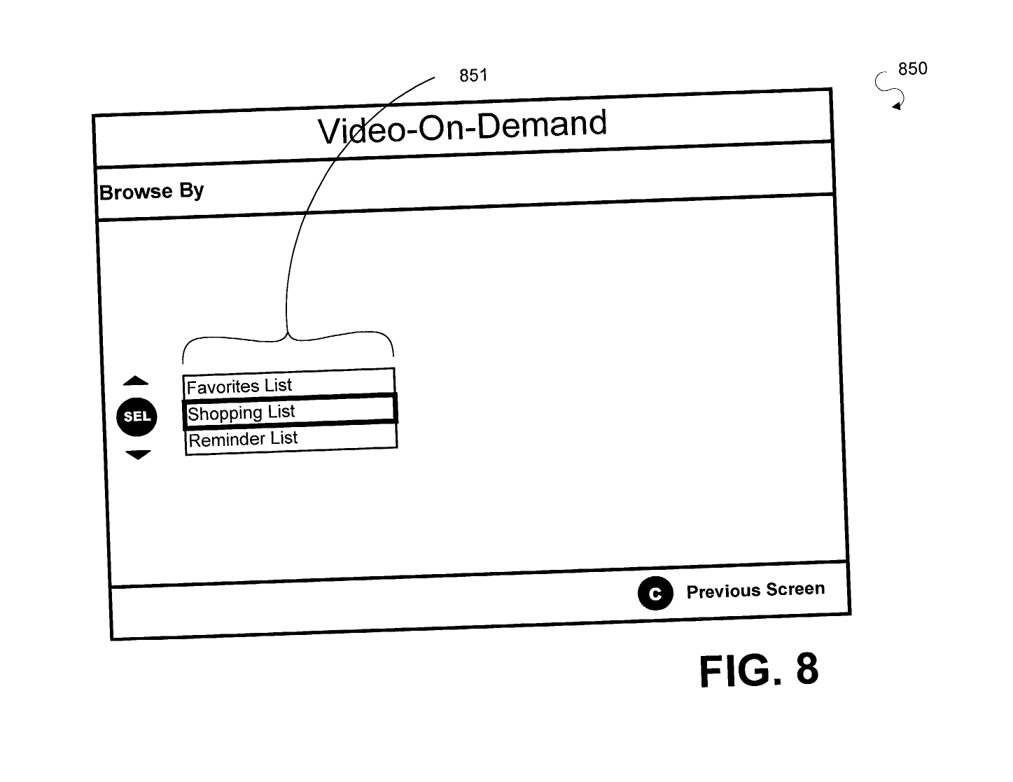

Pressing the browse by button “B” 389 results in the example browse by screen display 850 as illustrated in FIG. 8. From the browse by screen display 850, the user may select the category within the browse category list 851 to review what media content titles were dropped into the destination container icons 790 in the media content selection window 760 (FIG. 7). In other implementations, the user may select one of the destination container icons 790 in the media content selection window 760 to view the media content titles inserted in that list or table by using the keys in the remote control device 380 (FIG. 4A) to position a screen cursor on the desired destination container icon and then pressing the select key 387 (FIG. 4A).

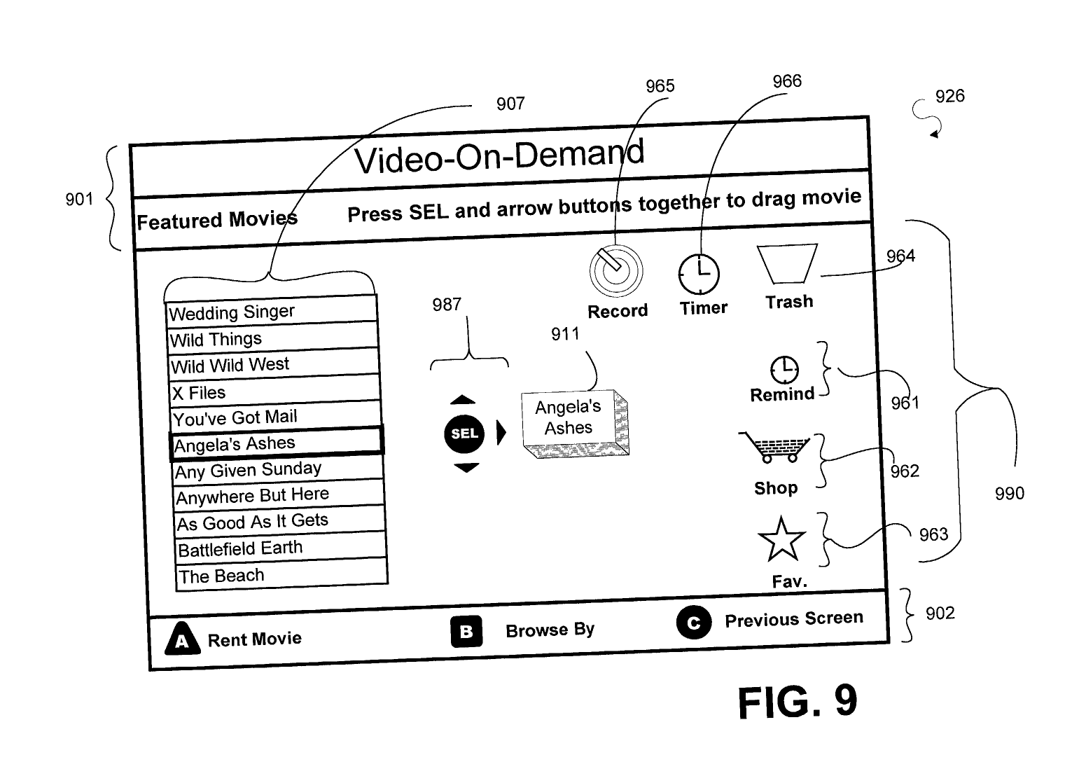

FIG. 9 is a screen diagram of an example screen display illustrating an example media graphical icon (as previously described) and an altered media content title list in response to the commencement of a drag and drop mode. In one implementation, the user is instructed in the header portion 901 to hold the select button 387 (FIG. 4A) of the remote control device 380 down together with one of the arrow buttons 382 (FIG. 4A) to cause movement of the media content title (i.e. to activate drag and drop functionality). The remote control device 380 (FIG. 4A), in cooperation with other DHCT 16 and related components as previously described, effect “drag and drop” functionality whereby a highlighted media content title is dragged and “dropped” into, for example, one of the destination container icons 990. By activating drag and drop functionality (i.e. commencing the drag and drop mode), feedback is preferably presented alerting the user that the user has activated the drag and drop mode. The feedback to the user includes, for example, an altered media content title list 907 (for example, shaded) and the presentation of a media graphical icon 911 (for example, a file folder with the media content title Angela's Ashes displayed). Alternatively, the media content title list 907 is not altered. While holding down the select key 387 of the remote control device 380 (FIG. 4A), the user presses a sequence of arrow keys 382 (FIG. 4A) according to where the desired destination container icon 990 is located on the screen. For instance, if the desired destination container icon 990 is shopping list icon 962, the user can “drag” a highlighted media content title in that direction by pressing the right arrow key 386 while continuing to hold down the select key 387. The media content selection window 926 is updated with the media graphical icon 911 in motion across the screen as the user performs the “drag” operation via continual arrow key 382 and select key 387 presses.

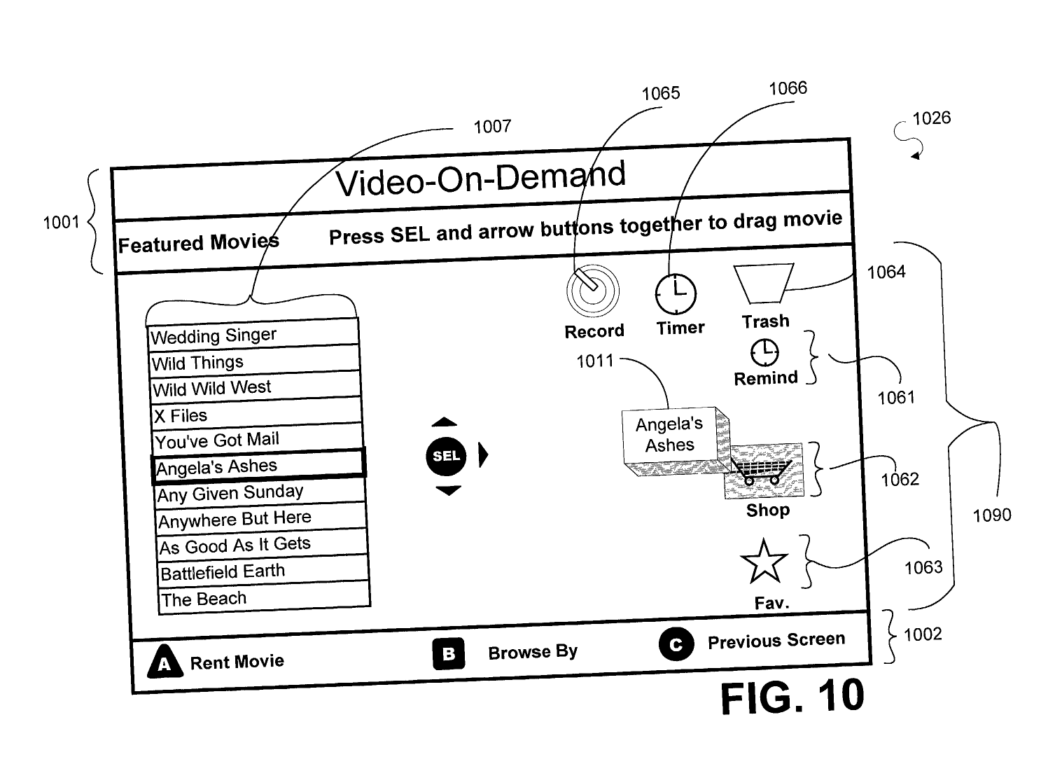

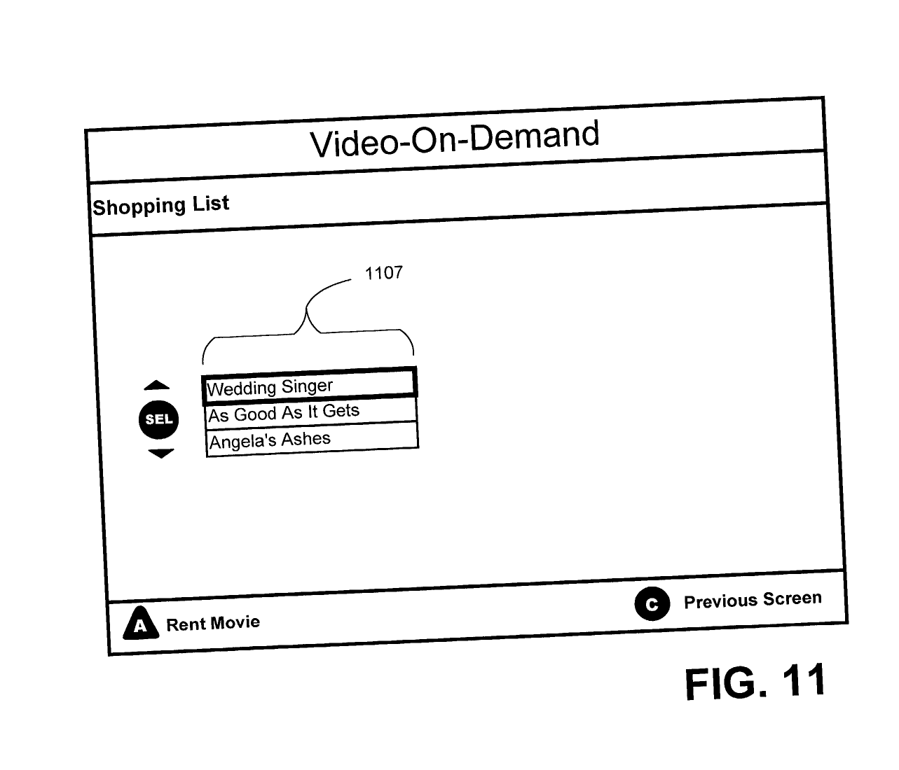

FIG. 10 is a screen diagram of an example screen display wherein the user adds the media content title Angela's Ashes to a shopping list using the drag and drop functionality. In one implementation, once the dragged media content title reaches the spatial domain of the shopping list icon 1062 (or any of the destination container icons 1090), the shopping list icon 1062 is dimmed (made darker) by MOD client application 363 (FIG. 3) to visually indicate to the user that the currently dragged media content title (depicted on the screen to the user with a media graphical icon 1011) has penetrated sufficiently into the destination container icon's “real-estate” and can be dropped in. Alternatively, the appearance of the media graphical icon 1011 representing the dragged media content title can be altered in other ways, such as a change in shape or being dimmed. Hence, if the user decides to drop the dragged media content title into the title list (not shown) of the representative destination container icon, the user preferably ceases the press of select key 387 and one of the arrow keys (382) on the remote control device 380 (FIG. 4A) and the media content title is inserted (or dropped off) into the respective title list. FIG. 11 is a screen diagram of an example screen display responsive to the user selecting the browse by button “B” 389 on the remote control device 380 (FIG. 4A), and selecting “Shopping List” from an example screen display such as that shown in FIG. 8. As noted, media content title Angela's Ashes is added to the current list 1107 of media content titles.

Each designated and user-created destination container comprises a list with respective list entries structured into a database of records, preferably in applications memory 370 (FIG. 3) that facilitates each list entry to correspond to a respective inserted media content information item and its associated information and attributes. In one implementation, a designated or user-created destination container comprises a list of “list entries” that are stored along with the associated information for each respective list entry in the container entry database (not shown) of applications memory 370. A list entry, for example, can be an inserted media content title that originated from a list displayed via the MOD application client 363 or an inserted program title that originated from the EPG application client's 377 displayed presentation.

When a dragged item is inserted into a destination container, information pertaining to the inserted item that is stored in the object memory 313 dedicated for a picked-up item, as described above, is copied into the container entry database records of the respective list entry in application memory 370. A list entry in a destination container thus includes information about the origination of the media content title (for example, either from an MOD title list or an EPG list), and one or more pointers to the corresponding database record in memory 352 (for example MOD database 311 or EPG database 378) where information associated with the inserted media content title are stored. Alternatively, rather than storing pointers to records in the container entry data base, the information contained in the records in one of the title origination databases (for example MOD or EPG databases) can be read and stored directly in the container entry database in applications memory 370.

Additional information relevant to a media content title in a destination container can be stored in the container entry database. Examples of additional information include a media content title's representative image and/or thumbnail, the time and date that the media content title was inserted into the destination container, identification of user that inserted the media content title into the destination container, user-created comments entered by an input device such as keyboard or remote control, and other possible attributes that may help the user recollect the user's train of thought at the time the user inserted the media content title into the destination container.

Each destination container comprising a list of list entries, each entry comprising a media content information item (e.g. MOD or program title) and its associated information, is copied from applications memory 370 to read/write non-volatile memory for purpose of recovery in the event of a power outage. Alternatively, if DHCT 16 has a local storage device, either internally or externally connected via a communication port or local storage interface, it can be used to store the destination container's list information rather than employing the MOD server or in addition to the MOD server.

Embodiments for providing feedback to alert the user that he or she is in the drag and drop mode may include one or more or a combination of the following: a media graphical icon formatted in any shape, a minimized media content list, a shaded media content list, an indented or protruded media content list, a pop-up window with instructional text, and/or a destination container list that is either highlighted, shaded, protruded, and/or maximized. Additional types of feedback within the scope of the embodiments of the present invention include aural and/or tactile feedback. Alternatively, feedback such as, for example, the media graphical icon 911 (FIG. 9) may not be presented of the actual translative motion.

Many different embodiments exist for providing drag and drop functionality. In one of many embodiments, drag and drop functionality may be enabled by the user “double-clicking” the select button 387 (FIG. 4A), wherein movement of the media content information item subsequently requires using the arrow keys 382 (FIG. 4A) only, and a single click to enter the media content information item in the destination container list, and a double click to end the drag and drop mode. In another embodiment, drag and drop functionality may be implemented by holding down the select button 387 until feedback is presented on the screen display indicating that drag and drop functionality has been enabled. Then the user may cause media content information item movement by using the arrow keys 382 (FIG. 4A) alone. The user may “single click” the select button 387 to insert the media content information item in the destination list. The user may cease the drag and drop mode by “double clicking” the select button 387, or holding down the select button 387 until feedback alerts the user that the drag and drop functionality is disabled. In yet another embodiment, drag and drop functionality may be implemented by separate drag and drop mode button on the remote control device 380, and/or by selecting a button (for example, the “A” 388, “B” 389, or “C” 390 buttons) corresponding to an “A”, “B”, or “C” symbol, respectively, on one of the screen displays that corresponds to drag and drop functionality. In another embodiment, the remote control device 380 may be configured with additional buttons, one as a drag button and another as a drop button (for example, remote control device 480 in FIG. 4B). To implement drag and drop functionality, the user simply selects the media content information item of interest and presses the drag button to commence a drag and drop mode. Then the user may release the drag button, and use the arrow keys to cause media content information item movement towards a destination on the screen. When the destination is reached, the user selects the drop button to insert the media content information item in the destination list. Alternatively, a “hybrid” of drag and drop functionality combined with the scrolling functions of the arrow keys 382 may be used, whereby after pressing the drag button 421 (FIG. 4B) the user manipulates arrow keys 382 to scroll through a destination container list, or between destination icons. Upon reaching the desired icon or list entry, the user presses the drop button 422. Alternatively, media content information item movement may be caused by the user using a disc or rotating ball on the remote control device 380 that provides for infinite directionality.

The present invention is not limited to media content titles or lists and containers. Instead, the scope of the present invention includes, in one example aspect, any subscriber network applications utilizing drag and drop functionality.

The Drag and drop logic 356 comprising drag and drop functionality of the present invention can be implemented in hardware, software, firmware, or a combination thereof. In the preferred embodiment(s), the drag and drop logic 356 is implemented in software or firmware that is stored in a memory and that is executed by a suitable instruction execution system. If implemented in hardware, as in an alternative embodiment, the drag and drop logic 356 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The Drag and drop logic 356, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Blocks in the flow chart of FIG. 6 should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred embodiments” are merely possible examples of implementations, merely setting forth a clear understanding of the principles of the inventions. Many variations and modifications may be made to the above-described embodiments of the invention without departing substantially from the spirit of the principles of the invention. All such modifications and variations are intended to be included herein within the scope of the disclosure and present invention and protected by the following claims.

Therefore, having thus described the invention, at least the following is claimed:

1. A method for providing interactive media services in a subscriber network television system, the method comprising the steps of:
receiving a first user input from a remote control device indicating a user's desire to select an item of displayed media content information; and
receiving a second user input from the remote control device indicating the user's desire to drag the item of the media content information to a destination desired by a user.

2. The method of claim 1, further comprising the step of receiving a third user input corresponding to a change in direction of the displayed media content information item.

3. The method of claim 1, further comprising the step of receiving a fourth and fifth user input corresponding to the cessation of the first user input and the second user input, respectively, to release the displayed media content information item at the destination desired by the user.

4. The method of claim 1, further comprising the step of displaying the movement of the displayed media content information item as the second user input is received.

5. The method of claim 1, wherein the step of receiving a second user input further includes the step of picking-up the selected media content information item.

6. The method of claim 1, wherein the step of receiving the second user input further includes the step of storing the coordinates of the original residence of the media content information item and the television screen coordinates of the media content information item as the item is dragged across the television screen in a memory in the client device.

7. The method of claim 6, further comprising the step of defining the screen coordinates as absolute screen coordinates.

8. The method of claim 6, further comprising the step of defining the screen coordinates as a change in the x-axis and y-axis of the television screen relative to the coordinates of the original residence of the media content information item.

9. The method of claim 1, further comprising the step of retrieving a media content information item and its corresponding media content information from the original residence of the media content title.

10. The method of claim 9, further comprising the step of storing the retrieved media content information from the original residence and storing the media content information in memory in the client device.

11. The method of claim 9, further comprising the step of associating the original residence location of the media content information with a pointer and storing the pointer in a memory in the client device.

12. The method of claim 1, further comprising the steps of storing at least one media graphical icon, representing the selected media content information item with a corresponding displayed media graphical icon, and storing the original residence coordinates and movement coordinates of the media graphical icon in a memory in the client device.

13. The method of claim 12, further comprising the step of emulating the movement of the media graphical icon corresponding to the translated media content information item by updating the location of the media graphical icon on the television screen repeatedly.

14. The method of claim 12, further comprising the step of changing the features of the media graphical icon depending on the media content information item type and the media content information item location on the television screen.

15. The method of claim 1, further comprising the step of dropping off the dragged media content information item in at least one graphical container displayed in at least one television screen.

16. The method of claim 15, further comprising the step of browsing a list of media content information items located in the graphical container.

17. The method of claim 15, further comprising the step of activating an operation by dropping off the dragged media content information item into a graphical activation container.

18. The method of claim 17, wherein the activating step further includes at least one of the following: activating a reminder timer and activating a media recording.

19. The method of claim 1, further comprising the step of displaying the media content information item.

20. The method of claim 19, wherein the displaying step is configured by a local client device.

21. The method of claim 19, wherein the displaying step is configured by a remote server.

22. The method of claim 1, further comprising the step of providing feedback to the user in response to at least one of the receiving steps.

23. A system for providing interactive media services in a subscriber network television system, the system comprising:
a memory for storing logic; and
a processor for executing the logic stored in memory, such that the logic is configured to generate a user interface on a screen, wherein the screen is responsive to user input, such that the logic is configured to cooperate with the remote control device to cause an item of media content information to be selected and translated across the screen 24. The system of claim 23, further comprising a media graphical icon that visually represents the media content information item on the display screen.

25. The system of claim 23, wherein the media graphical icon includes changing features depending on the media content information item type and the media content information item location on the display screen.

26. The system of claim 23, wherein the memory further comprises the coordinates of the original residence of a picked-up media content information item and a corresponding media graphical icon and the display screen coordinates of the media content information item and the media graphical icon the media content information item and the media graphical icon are moved across the display screen.

27. The system of claim 23, wherein the screen coordinates are stored as at least one of the following: absolute screen coordinates and coordinates relative to the original residence of the media graphical icon and the media content information item.

28. The system of claim 23, wherein the memory further comprises a media content title and its corresponding media content title information.

29. The system of claim 23, further comprising at least one graphical container on the display screen, wherein the graphical containers represent destinations for at least one of the moved media content information items.

30. The system of claim 29, wherein the graphical containers include browsable list entries for the media content information items.

31. The system of claim 29, wherein the graphical containers have alterable features that provide feedback when the media content information item on the television screen is spatially close to the graphical container.

32. The system of claim 29, wherein at least one of the graphical containers include graphical activation containers for enabling operations on the media content information items.

33. The system of claim 32, wherein the graphical activation containers include a reminder timer container and a media content recording container.

34. The system of claim 23, wherein the television screen comprises a displayed origin for at least one media content information item to enable the user to select the desired media content information item.

35. The system of claim 34, wherein the displayed origin has alterable features that provide feedback when a media content information item on the television screen is selected.

36. The system of claim 34, wherein the displayed origin includes at least one of the following: a table with entries and a graphical icon.

37. The system of claim 23, wherein the remote control device further comprises at least an activation button and at least one arrow key.

38. The system of claim 37, wherein the logic is further configured to receive a signal from the remote control device corresponding to the concurrent pressing of the activation button and at least one of the arrow keys to cause a corresponding media content information item movement, wherein the logic is further configured to receive a signal from the remote control device corresponding to a subsequent deactivation of the activation button to cause a corresponding media content information item movement completion.

39. The system of claim 37, wherein the logic is further configured to receive a signal from the remote control device corresponding to quickly repeated pressing of the activation button and releasing the activation button to cause the commencement of a movement mode, wherein the logic is further configured to receive a signal from the remote control device after commencement of the movement mode, wherein the signal corresponds to a subsequent pressing of at least one of the arrow keys, wherein the logic responsively causes the media content information item movement, wherein the logic is further configured to receive a signal from the remote control device corresponding to the subsequent pressing of the activation button to cause the media content information item movement completion.

40. The system of claim 37, wherein the logic is further configured to receive a signal from the remote control device corresponding to an extended duration single pressing of the activation button and subsequent release of the activation button to cause the commencement of a movement mode, wherein the logic is further configured to receive a signal from the remote control device corresponding to the pressing of at least one of the arrow keys to cause the media content information item movement, wherein the logic is further configured to receive a signal from the remote control device corresponding to the subsequent pressing of the activation button to cause the media content information item movement completion.

41. The system of claim 37, wherein the remote control device further includes a movement mode button, wherein the logic is further configured to receive a signal from the remote control device corresponding to the pressing of the movement mode button to commence the movement mode, wherein the logic is further configured to receive a signal from the remote control device corresponding to the pressing of at least one of the arrow keys to cause the media content information item movement, wherein the logic is further configured to receive a signal from the remote control device corresponding to the pressing of the activation button to cause the media content information item movement completion.

42. The system of claim 37, wherein the remote control device further includes a second activation button configured by the logic to commence the media content information item movement, and a third activation button configured by the logic to complete the media content information item movement.

43. The system of claim 23, wherein the logic is implemented in a remote server.

44. The system of claim 23, wherein the logic is implemented in local client device.
